(19) United States
(12) Patent Application Publication
(10) Pub. No.: US 2006/0289421 A1
(43) Pub. Date: Dec. 28, 2006

(54) Portable heated seating

(75) Inventors: Grigore Axinte, Bellevue, WA (US); Dragos Axinte, Bellevue, WA (US); John Lu, Renton, WA (US); Russell Borgmann, Bellevue, WA (US); Amanda Wu, Seattle, WA (US)

Correspondence Address: WILMER CUTLER PICKERING HALE AND DORR LLP, 1875 PENNSYLVANIA AVE., NW, WASHINGTON, DC, 20004, US

(73) Assignee: Hyperion Innovations, Inc., Bellevue, WA (US)

(21) Appl. No.: 11/401,452

(22) Filed: Apr. 11, 2006

Related U.S. Application Data
(60) Provisional application No. 60/670,327, filed on Apr. 12, 2005.
(60) Provisional application No. 60/785,370, filed on Mar. 24, 2006.

(51) Int. Cl. H05B 3/00; H05B 1/00

(52) U.S. Cl. 219/217

(57) ABSTRACT

In accordance with principles described herein, portable heated seats, and methods and systems for using the same, are provided that overcome some (or all) of the problems commonly associated with existing seats. These portable heated seats are easily transportable, and are preferably provided with cushion material to compensate for various seating conditions that may otherwise be faced by a user. One or more heating elements, preferably made of flexible graphite felt, are also provided in each portable heated seat. The heat settings of the one or more heating elements are controlled by one or more on/off switches, open loop temperature regulators, pressure push switches, sensor switches, and/or fuse circuits. A backrest (similarly heated or not heated) may also be used in association with the portable heated seat. Various alternative embodiments are also disclosed.

### RELATED APPLICATIONS

This application claims the benefit of priority from U.S. Provisional Application No. 60,670,327, filed Apr. 12, 2005, and U.S. Provisional Application No. 60/785,370, filed Mar. 24, 2006, all of which hereby incorporated by reference.

### FIELD OF THE INVENTION

The present invention relates to seating, and more particularly, to portable heated seating.

### Background

Cushioned seat pads are commonly used by individuals while attending sporting activities, concerts, or other venues where comfortable seating is not readily available. While known portable, cushioned seat pads are quite versatile, these seats are of limited value when used outdoors in very cold weather conditions. Most seat pads completely lack heating capability. Known seat cushions that do provide integrated heating are not capable of power efficient and environmentally robust portable heating. For example, such seat pads typically require an AC power outlet to supply heating, which undesirably limits the portability of the seat pads to locations in which an AC power outlet is available.

Further, existing heated seats, whether portable or otherwise, often experience one or more failures due to a break in the heating circuit. For example, in many applications, a wire filament or similar resistive heating element is used to provide the heat function to a seat. However, it is not uncommon in these applications for a single break or loss of connection in such a wire or similar element to result in a complete circuit failure (and thus, the elimination of the heating function). Moreover, repairs of such breaks or losses of connection are often not feasible due to the permanent manner of construction of the seats, or are undesirably costly.

Accordingly, it is desirable to provide an improved portable heated seating apparatus.

### SUMMARY

In accordance with principles of the invention, portable heated seats and methods and systems for using the same are provided. According to various embodiments, these portable heated seats are easily transportable between different locations (e.g., using a handle or by simply gripping one or more portions thereof), and are provided with cushion material to compensate for harsh (e.g., hard) seating conditions that a user would otherwise face.

One or more heating elements are also provided in each portable heated seat, some or each of which can be made of a flexible graphite material, or a mix of carbon and silver paste (or ink). According to various embodiments, the heater material being used has a large surface area that facilitates electrical contacts. Moreover, according to various embodiments, the heater material is cut into a circuitous serpentine configuration. In this manner, it is possible to use a resistive material having lower resistivity than would otherwise be required, given that, for a desired total resistance level, the required resistivity is inversely proportional to the length of the heating element.

In accordance with principles of the invention, the heating function is enabled using one or more portable power sources, such as batteries. These power sources may be situated internal to the heated seat, or attached to the exterior. According to various embodiments, the heat settings of the one or more heating elements are controlled by one or more on/off switches, open loop temperature regulators, pressure push switches, sensor switches, and/or fuse circuits. A cutoff circuit may also be used to deactivate the heating function when the power level of the power source is determined to be below a certain threshold level. Moreover, a lighting element may also be used to indicate to a user when the heating function is being used.

According to various embodiments, a backrest (similarly heated or not heated) may be connected to the portable heated seat. The portable heated seats (and optional backrests) may be used in a variety of settings, and may be used to compensate for cold temperatures, as well as for therapeutic purposes, and in various other situations and settings.

Accordingly, a portable heated seating apparatus is disclosed that comprises a cushion material for providing seating support, a heating element positioned at or substantially near a surface of the cushion material for generating heat from electrical current, and a power source located within the cushion material for supplying current to the heating element. The cushion material includes an opening for removable insertion of the power source. The portable heated seating apparatus additionally includes a user-operated power selector located at an exterior of the seating apparatus, operatively connected between the power source and the heating element for a user to selectively activate or deactivate the seating apparatus.

A portable heated seating apparatus is also disclosed that comprises a heating element for generating heat from electrical current, a temperature controller operatively connected to the heating element to control activation of the heating element based on pulse width modulation, and a user-operated power selector adapted for selection of a power level. The temperature controller adjusts a pulse width duty cycle in correspondence with the selected power level to control a temperature level generated by the heating element.

Additionally, a portable heating device is disclosed that comprises a heating element for generating heat from electrical current, a temperature controller operatively connected to the heating element to control activation of the heating element based on pulse width modulation, a removable and rechargeable power source adapted for insertion within the device for supplying current to the heating element and the temperature controller; and a sensor in communication with the temperature controller. The temperature controller disconnects current from the heating element when it is determined via the sensor that the portable heating device is not in use.

### BRIEF DESCRIPTION OF THE DRAWINGS

Embodiments of the present invention will be more apparent upon consideration of the following detailed description, taken in conjunction with the accompanying drawings, in which like reference characters refer to like parts throughout, and in which:

FIG. 1 depicts a portable heated seating apparatus according to at least one embodiment of the present invention;

FIG. 2 depicts a portable heated seating apparatus according to at least a second embodiment of the present invention;

FIG. 3A depicts an arrangement of a flexible graphite heating element according to at least one embodiment of the present invention;

FIG. 3B depicts a tracing of a heating element comprised of silver and carbon paste, according to at least a second embodiment of the present invention;

FIG. 3C depicts a cross-section of a heater assembly comprised of silver and carbon paste, according to at least a second embodiment of the present invention;

FIG. 3D depicts a heater assembly comprised of silver and carbon paste positioned on a heated seating cushion, according to at least a second embodiment of the present invention;

FIG. 4 depicts an arrangement of a flexible graphite heating element according to at least one embodiment of the present invention;

FIG. 5 depicts an arrangement of a flexible graphite heating element according to at least one embodiment of the present invention;

FIG. 6 is a schematic of a heating circuit associated with a portable heated seating apparatus according to at least one embodiment of the present invention;

FIG. 7A is a schematic of a heating circuit incorporating an open loop temperature regulator for a portable heated seating apparatus, according to at least one embodiment of the present invention;

FIG. 7B is a circuit schematic of circuitry for use with a pulse width modulation integrated circuit for an open loop temperature regulator, according to at least one embodiment of the present invention;

FIGS. 8A-C illustrate three duty cycles associated with the open loop temperature regulator shown in FIG. 7A according to at least one embodiment of the present invention;

FIG. 9 is a schematic of a heating circuit associated with a portable heated seating apparatus according to at least one embodiment of the present invention;

FIG. 10 is a schematic of a heating circuit associated with a portable heated seating apparatus according to at least one embodiment of the present invention;

FIG. 11 is a schematic of a heating circuit associated with a portable heated seating apparatus according to at least one embodiment of the present invention;

FIGS. 12A-C depict a portable seating apparatus including a heated seat and backrest portions according to at least one embodiment of the present invention;

FIG. 13 is a schematic of a heating circuit associated with a portable heated seating apparatus according to at least one embodiment of the present invention;

FIG. 14 is a schematic of a heating circuit associated with a portable heated seating apparatus according to at least one embodiment of the present invention;

FIG. 15 depicts a portable heated sleeping bag unit according to at least one embodiment of the present invention;

FIG. 16 is a diagram of a microcontroller assembly for use with a heated seating apparatus in accordance with at least one embodiment of the invention;

FIG. 17 depicts a user interface for use with a heated seating apparatus in accordance with at least one embodiment of the invention;

FIG. 18 depicts a perspective view of a heated seating apparatus including integrated pockets, in accordance with at least one embodiment of the invention;

FIG. 19 depicts a perspective view of a heated seating apparatus with a slot for an integrated battery pack, in accordance with at least one embodiment of the present invention; and

FIG. 20 depicts a perspective view of a heated seating apparatus with an exterior covering material, in accordance with at least one embodiment of the present invention.

### DETAILED DESCRIPTION OF THE PREFERRED EMBODIMENTS

The following describes portable heated seating apparatus and methods and systems for using the same. The details included herein are for the purpose of illustration only and should not be understood to limit the scope of the invention. Moreover, certain features that are well known in the art are not described in detail in order to avoid complication of the subject matter described herein.

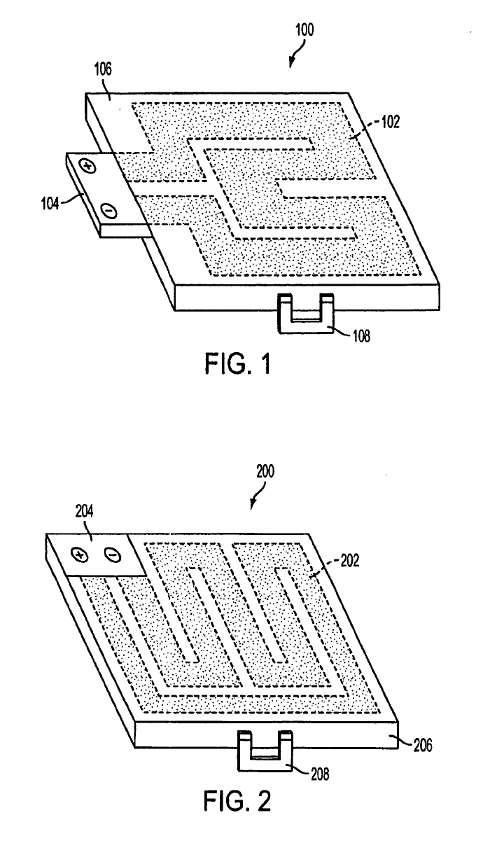

A portable heated seat is provided that includes at least one heating element for bringing the surface temperature of the seat to a temperature or maintaining a temperature above the temperature of the ambient air. For example, as an exemplary embodiment of the present invention, portable heated seat 100 illustrated in FIG. 1 includes a heating element 102, a power source 104, a seating cover 106, and a grip or handle 108. As shown below, heated seat 100 may also include cushion material (e.g., made from elastomer foam) or other suitable material for enhancing the comfort of seat 100 as experienced by a user. In particular, cushion material and/or other suitable material may be located below and/or above heating element 102.

Power source 104 of heated seat 100 shown in FIG. 1 may be any suitable type of power source. For example, power source 104 may include one or more “AA” or “D” sized batteries, one or more Lithium-Ion batteries, one or more nickel-metal-hydride batteries, and/or one or more other types of batteries. According to various embodiments, the batteries of power source 104 may be rechargeable. In this case, the batteries of power source 104 may be recharged by removing the batteries and placing them in a separate charging device, or by connecting a charger directly to the heated seat 100. Moreover, portable power devices other than batteries may also be used. The batteries may be replaceable or, when rechargeable batteries are being used, the rechargeable batteries may be permanently attached to and/or enclosed by heated seat 100. If an AC power device is to provide power to heated seat 100, an AC/DC converter (not shown) can be used to convert from AC to DC for use by heated seat 100. The invention is not limited in these manners.

As shown in FIG. 1, power source 104 may be situated adjacent (external to) the portion of heated seat 100 on which a user will sit (the “sitting portion”). In this case, seating cover 106 (when it is being used) may serve to protect the sitting portion of heated seat 100 and the power source 104 from the environment. According to various embodiments, seating cover 106 may be made from vinyl or another suitable material that is able to withstand rain, low and high temperatures, moisture, and the like.

It is also contemplated that the exterior of power source 104 may be rigid and environmentally robust, such that power source 104 remains adequately protected when seating cover 106 is not designed to cover power source 104. In any event, seating cover 106 may be made of any suitable material, preferably a nylon or similar material that is well suited for protecting the internal components from rain, moisture, and the like. Additionally, according to various embodiments, cover 106 may be removable (e.g., using a zipper or buttons), and may be machine or hand washable. Moreover, the bottom of seating cover 106 may be provided with one more gripping elements (not shown) that may be used to prevent heated seat 100 from sliding when in use on a slippery surface (e.g., an aluminum bleacher seat).

Optional grip or handle 108 shown in FIG. 1 may be any suitable type of handle that is configured to enable a user to transport heated seat 100 between different locations. For example, handle 108 may resemble a rigid briefcase handle, a piece of string attached at two locations as shown in FIG. 1, or any other suitable type of handle. Although not shown, it is contemplated that optional handle 108 not be present. As another alternative, power source 104 may be used (with or without modification) as a grip or handle for transporting heated seat 100 between different locations. Although not shown, according to various embodiments, it is contemplated that a portion of heated seat 100 be extractable, where the extracted portion acts as a handle for a user for gripping seat 100.

FIG. 2 illustrates another heated seat 200 according to at least one embodiment of the present invention, which, similar to heated seat 100 shown in FIG. 1, includes a heating element 202, a power source 204, an optional seating cover 206, and a grip or handle 208. It is noted that, unlike power source 104 shown in FIG. 1, power source 204 shown in FIG. 2 is situated internally to the main portion of heated seat 200, embedded therein (either removably or permanently). It will be understood that, although FIG. 2 shows power source 204 in a particular location, the invention is not limited in this manner. Particularly, as described below in further detail, the power source 204 may be positioned within the padding or foam of the heated seat.

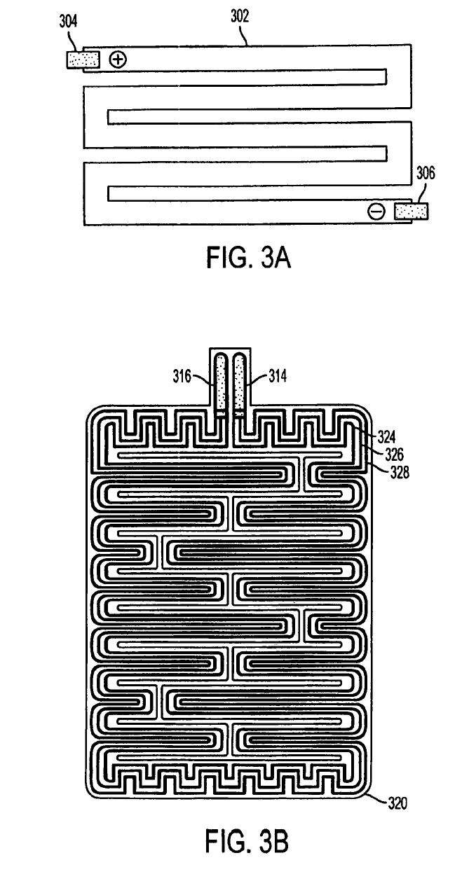

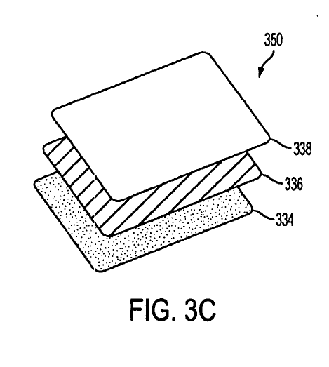

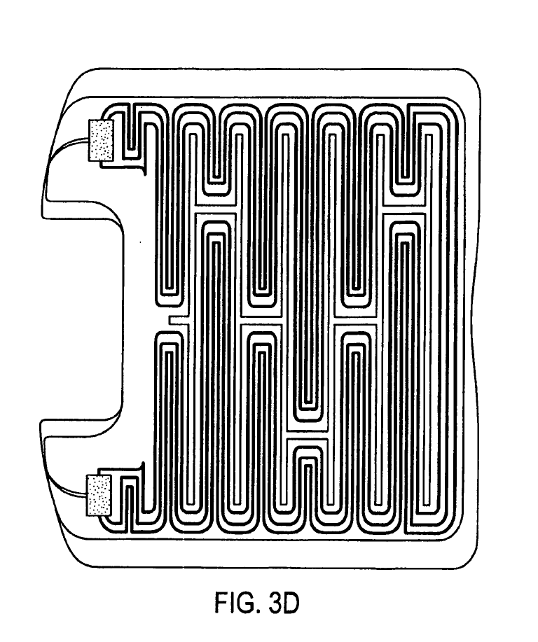

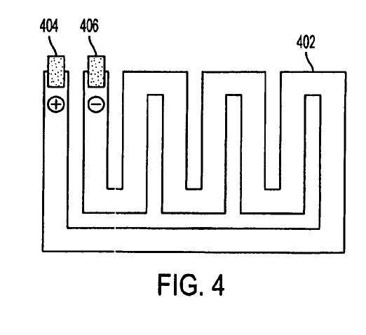

The heating elements (e.g., heating elements 102 and 202) that are used in accordance with various embodiments of the present invention are now explained in greater detail with reference to FIGS. 3-5. FIG. 3A shows one configuration of a heating element 302 for use in a portable heated seat such as those illustrated in FIGS. 1 and 2. According to various embodiments, heating element 302 is made of a mix of carbon and silver paste or ink, silk-screened onto a substrate. Alternatively, the heater may be made of flexible carbon or graphite material, such as flexible graphite foil. According to other embodiments, heating element 302 may be made of a flexible graphite fabric, or a flexible graphic felt, such as TDG soft graphite felt manufactured by SGL Carbon Group of Valencia, California. Moreover, according to various embodiments, the thickness of the flexible graphite being used is approximately ⅛ inch. It will be understood that the invention is not limited by the particular thickness, grade, or weave of the flexible graphite heating element 302 that is used.

As shown in FIG. 3A, heating element 302 may be cut into a circuitous serpentine configuration. It is noted that, according to various embodiments, the spacing of heating element 302 shown in FIG. 3A (and the spacing present in other heating elements described herein) may remain free of materials, or may include, for example, insulation material. The invention is not limited in this manner. As shown in FIG. 3A, heating element 302 may include electrical contacts 304 and 306 on either end. According to various embodiments, electrical contacts 304 and 306 are formed by attaching metal plates (or similar components) to the top and bottom surfaces of either end of heating element 302. In alternate embodiments, only one of the top and bottom surfaces of either end of heating element 302 will be in contact with electrical contacts 304 and 306, respectively. Electrical contacts 304 and 306 may be made, for example, of copper or brass. Moreover, electrical contacts 304 and 306 may, for example, be pressed onto either end of heating element 302, and may be screwed or riveted thereon. Moreover, although not shown, more than one electrical contact may be used on either or both ends of heating element 302. The invention is not limited in this manner.

FIGS. 3B and 3D illustrate a heater assembly 320 of at least one embodiment, made of a silver/carbon paste and having a circuitous serpentine configuration. As can be seen, the heater assembly is comprised of three silk-screen traces, 324, 326, 328, each in parallel and closely adjacent to each other. By arranging the traces in parallel, the heater will still provide a circuitous connection to provide heating capability if one or even two of the trace lines should have a break in continuity. Further, having three traces in parallel maximizes the heat distribution to be applied to the seat. This arrangement avoids “hot spots” and “cool spots” on the seat to provide a more comfortable environment for the user. The heating element 320 may include electrical contacts 314 and 316 on either end. As will be described below in further detail, contacts 314 and 316 may connect to output pins of a microcontroller, which controls the application of electrical power to the heater assembly.

FIG. 3D illustrates a heater assembly 320 positioned on a heated seat in accordance with at least one embodiment of the present invention. As can be seen, the heater assembly substantially covers the surface of the heated seat cushioning 330. As described below in further detail, the heater assembly 320 can be attached to the foam cushioning 330 via an adhesive material.

As shown in FIG. 3C, a heater made of silver and carbon paste can be comprised of three components. The heater 350 is a mixture of silver and carbon paste on either a substrate, such as polyethylene terephthalate (PET), a polyester thermoplastic polymer, or on silicone. An acrylic adhesive backing 334 is provided as an opposite side, such that one side is an adhesive, and the other side is polyester film. On the polyester film, a silver carbon paste is screen printed, as 336. It is then sent through ovens and cured, and then a top layer of polyester film 338 is applied. The final product is very flexible and durable.

After the paste is printed on a substrate, the heater is die cut into shape. The gaps between bars (as shown in FIG. 3D) allow freedoms of deflection so that the heater is more durable. As it is die cut, two holes for the connector are punched at the beginning and end of the traces. This allows rivets and washers to be mounted, before the backside adhesive is applied, to complete the process. Wires are later soldered to the connectors.

Unlike a conventional nichrome wire heater assembly, heaters made from silver/carbon paste silk-screened onto a surface and from graphite fabric are flat. This is particularly beneficial for use in a heated seat because it can be positioned comparatively closer to the outer seating surface of the apparatus without being noticeable or uncomfortable during use. That is, while a user may discern an arrangement of wires placed just below a conventional seating surface, the flat heater assembly 350 is unnoticeable by the user. As a result, the heater can be placed closer to the surface, without excessive padding between the heater and the external fabric coating. This allows the heater to work more efficiently, with less heat being absorbed by the padding. Further, it enables the device to heat more quickly. Additionally, because the traces are comparatively wider than a nichrome wire arrangement, the heater assembly provides a more even heat distribution. The wider traces also are less likely to break, because a small dent or nick on the trace will not necessarily break the electrical connection.

An exemplary calculation associated with the dimensions of heating element 302 is now described. In an embodiment using flexible graphite, the initial heat up power (Pᵢ) may be 20 W, the resistivity (p) of the graphite felt being used along the transverse direction may be 0.0655 Ω-inch, the initial battery pack voltage (Vᵢ) when the heated seat circuit is loaded may be 12 V, and that the thickness (T) of the heating element may be ⅛, or 0.125, inches. Of course, all of these dimensions may be varied. For example, the voltage may be 14, 15, or beyond 16 V, depending whether the source is a battery, a car adapter, or an AC adapter. Assuming these dimensions, however, the current (I) is equal to Pᵢ/Vᵢ=20/12=1.67A, and the total resistance of heating element 302 (R) is equal to Vᵢ/I=7.19 Ω. Using the equation R=(p*L)/(W*T), the length (L) to width (W) ratio of resistive element 302 may be computed as follows: L/W=(R*T)/ρ=(7.19 Ω* 0.125 in)/(0.0655 Ω-in ) =13.7. According to various embodiments, if the width (W) of heating element 302 is 2.5 inches, heating element 302 is configured such that its length (L) is equal to 34.25 inches.

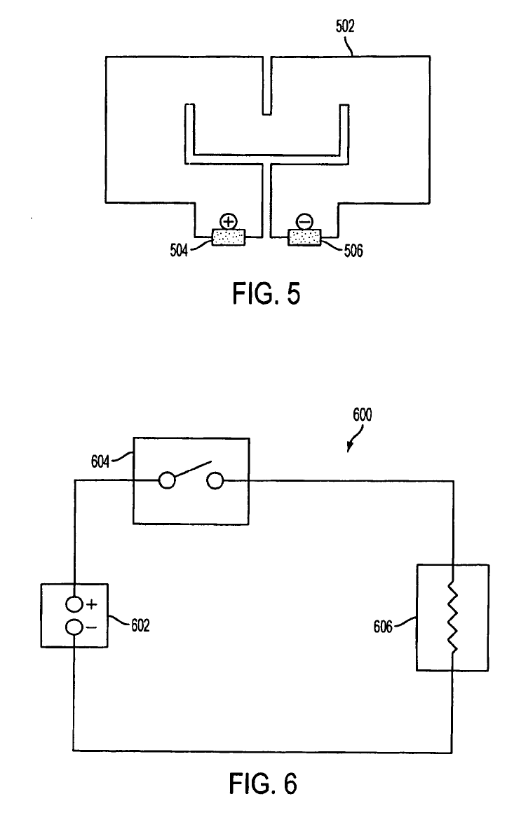

FIG. 4 shows another circuitous serpentine configuration of a flexible graphite heating element 402 with electrical contacts 404 and 406 in accordance with various embodiments that is similar to the one shown using dotted lines in FIG. 2. It is noted that, according to various embodiments, the use of a configuration (such as that shown in FIG. 4) in which the ends of the heating element are in close proximity to each other may be desired, e.g., to facilitate connection to the positive and negative terminals of the power source being used. FIG. 5 shows yet another configuration of a circuitous serpentine flexible graphite heating element 502 with electrical contacts 504 and 506 in accordance with various embodiments that is similar to the one shown using dotted lines in FIG. 1, and which also includes ends that are in close proximity to each other. Other configurations are also contemplated.

The particular dimensions and configuration of the heating element being used (e.g., heating element 102, 202, 302, 402, or 502) may be chosen (based, e.g., on calculations such as those described above) in any suitable manner such that specific desired heater resistance requirements are met. For example, for a heater made of silver and carbon tracing to sustain a battery life of several hours, batteries can be chosen to provide approximately 20W of power, and the heater resistance can be selected to be in the range of 12 ohms, with a V initial of approximately 15.7V.

FIG. 6 shows a simplified diagram of a circuit 600 associated with a portable heated seat. The circuit shown in FIG. 6 includes power source 602, on/off switch 604, and heating element 606. As explained above in connection with FIGS. 1-2, power source 602 may be any suitable type of power source. On/off switch 604 is provided to enable a user to manually turn the heating function of the heated seat being used ON and OFF. Heating element 606 may be any suitable type of heating element in accordance with the preferred embodiments, such as carbon silver paste or a flexible graphite heating element such as explained above in connection with FIGS. 1-5.

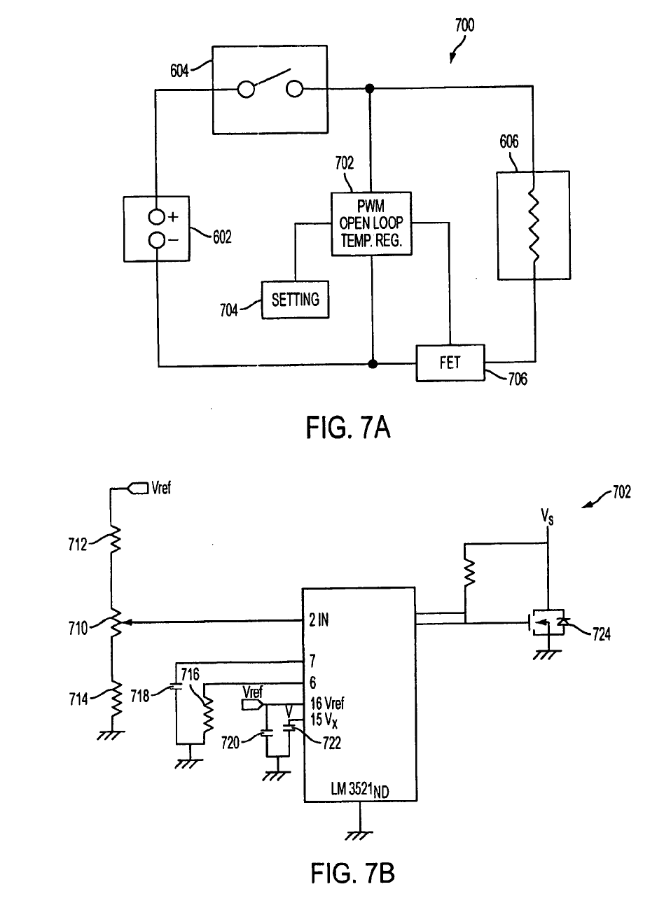

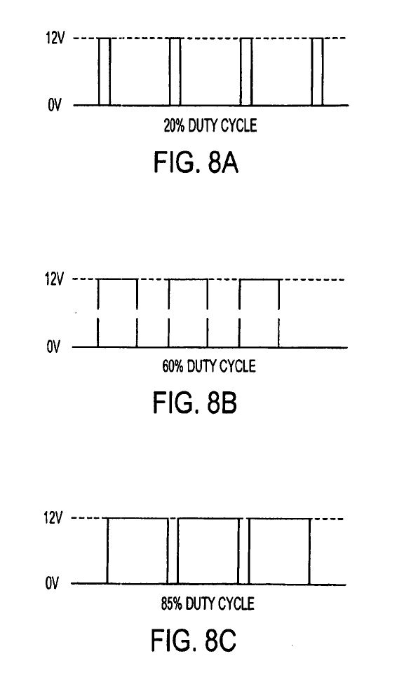

FIG. 7A shows another circuit 700 associated with a portable heated seat. Circuit 700 is similar to circuit 600 shown in FIG. 6, but also includes an open loop temperature regulator, such as pulse-width-modulator (PWM) circuit 702, for regulating the temperature of a heated seat. A user may manipulate a control setting 704 (e.g., a switch, knob, or the like) that controls field effect transistor (FET) 706 or another suitable type of circuit device, which in turn controls the amount of time that heating element 606 is activated. For example, FIGS. 8A-8C illustrate three possible duty cycles associated with PWM 702, which correspond, for example, to three different settings of control setting 704. Other duty cycles may also be implemented. Moreover, it is contemplated that, in various embodiments, control settings can be configured for a certain number of discrete settings, while in other embodiments, a substantially unlimited number of settings will be possible (e.g., using a knob rather than a switch mechanism).

FIG. 7B is a schematic diagram showing PWM circuit 702 according to at least some of the preferred embodiments. It will be understood that, although not shown, a closed loop temperature regulator may also be used according to various embodiments. Alternatively, the circuitry can include an integrated circuit controller (microcontroller), as will be described below in further detail. In FIG. 7B, PWM circuit 702 is National Semiconductor chip LM 3524, a dedicated PWM circuit. As inputs, the circuit includes a potentiometer 710, which is a variable resistor that changes the voltage at pin 2 to change the duty cycle of the PWM. Resistors 712 and 714 provide a voltage divider from VREF for the potentiometer. Together, resistor 716 and capacitor 718 set the oscillation frequency. Capacitors 720 and 722 are used to stabilize the line. Finally, the output to FET 724 is for turning on and off the heater in accordance with the PWM settings.

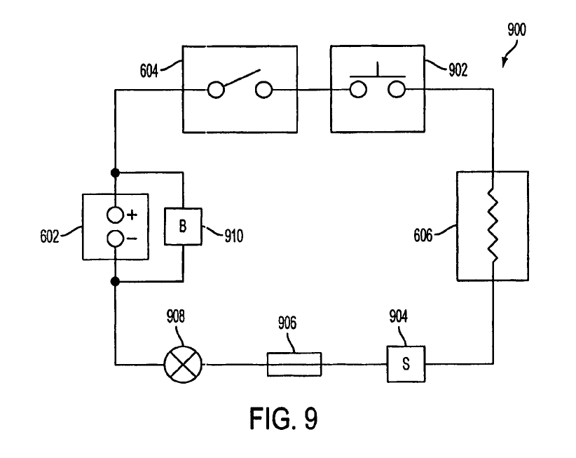

FIG. 9 shows yet another simplified circuit 900 associated with a portable heated seat according to one or more embodiments. Circuit 900 is similar to circuit 600 shown in FIG. 6, but also includes a pressure activated push switch 902 that may be activated by a user of the portable heating seat. For example, assuming the user has switched on/off switch 604 to the ON position, the circuit shown in FIG. 9 is automatically activated when the user sits or otherwise exerts pressure on pressure switch 902, and is automatically deactivated when the user stands or otherwise removes the exerted pressure from pressure switch 902. In this manner, power source 602 may be preserved by turning off the heating function when the user is not exerting pressure on pressure switch 902 (e.g., because the user is not using the heated seat at the time).

As shown, circuit 900 also includes a sensor switch 904 that is designed to sense whether the heated seat is in a position that is suitable for a user to sit thereon, and to deactivate circuit 900 when this is not the case. For example, assuming that on/off switch 604 is in the ON position, and that pressure switch 902 is either not present or pressure is somehow being exerted thereon, according to various embodiments, circuit 900 may nonetheless be deactivated when sensor 904 determines that the heated seat is being transported (and thus, is not currently being used). For example, sensor 904 may be configured to detect motion and/or angular (e.g., non-horizontal) positioning. It is noted that sensor 904 may operate using any suitable means of detection, including, for example, a level detector or a gyroscope.

Also included in circuit 900 shown in FIG. 9 is a fuse circuit 906. Fuse circuit may be any suitable type of fuse circuit that is capable of providing overcurrent protection. For example, fuse circuit 906 may be designed to melt and open circuit 900 under abnormally high electric loads. Alternatively, according to various preferred embodiments, fuse circuit 906 will operate to only temporarily open circuit 906. In this manner, the triggering of fuse circuit 906 may not require servicing of the heated seat. As also shown in FIG. 9, circuit 900 may include an on/off indicator 908 that lights up when the circuit is active, thereby providing the user with an indication relating to the operating status of the heated seat. According to various embodiments, a light emitting diode (LED) may be used for this purpose, although the invention is not limited in this manner. Circuit 900 shown in FIG. 9 also includes a cutoff circuit 910 that is designed to deactivate power source 602 when its power level is determined to be low (e.g., below a predetermined threshold voltage level). Although one particular configuration of cutoff circuit 910 is shown in FIG. 9, it will be understood that other configurations are also contemplated.

It is noted that, although circuit 900 includes both on/off switch 604 and pressure activated switch 902, the invention is not limited in this manner. That is, according to at least some of the preferred embodiments, on/off switch 604 will not be present when pressure activated switch 902 is being used. Moreover, although not shown, according to various embodiments, a bypass switch or similar mechanism maybe used to bypass (disable) any or all of pressure switch 902, sensor switch 904, fuse circuit 906, on/off indicator 908, and cutoff circuit 910.

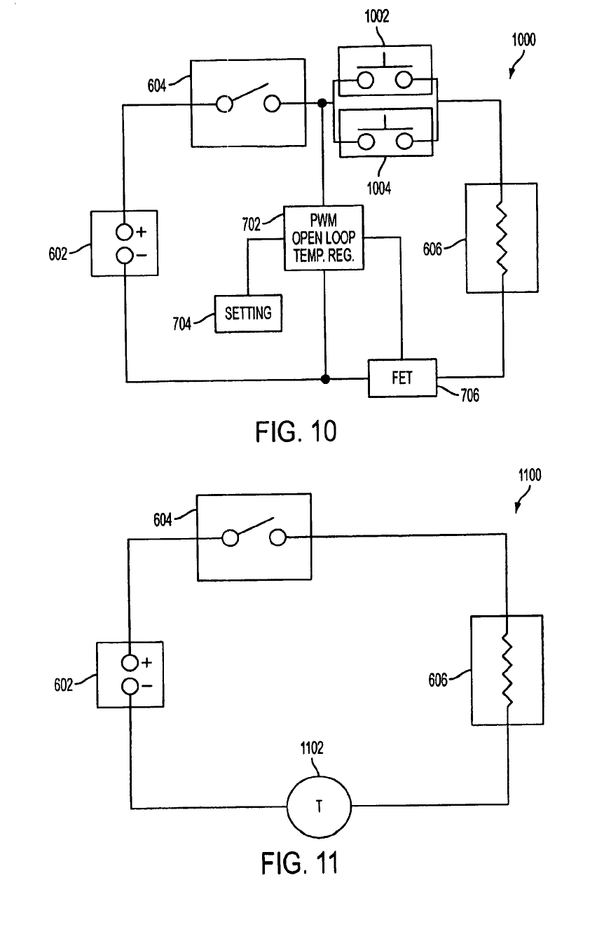

FIG. 10 shows yet another simplified circuit 1000 associated with a portable heated seat according to various embodiments. Circuit 1000 is similar to circuit 700 shown in FIG. 7A, but also includes a pair of pressure activated push switches 1002 and 1004 that may be activated by a user of the portable heating seat. As shown, pressure activated switches 1002 and 1004 are placed in parallel in circuit 1000, such that when pressure is exerted on either, circuit 1000 is activated. One advantage associated with using a pair of pressure activated switches 1002 and 1004 in this manner, rather than a single pressure switch (as with circuit 900 shown in FIG. 9), is that a user of the heated seat will be more likely to activate at least one of switches 1002 and 1004 (especially when they are placed apart from each other) when using the heated seat. Moreover, according to various embodiments, more than two pressure switches may be used. For example, respective pressure switches (e.g., connected in parallel) may be placed in at four corners of the heated seat, and also in the center, thereby further reducing the chances that circuit 1000 will not be activated when the heated seat is in use. According to various other embodiments, when more than one pressure switch is being used, one or more of these switches may be placed in series such that pressure must be exerted on each in order for circuit 1000 to be active. This may be desirable, for example, to prevent accidental activation of circuit 1000. It is also contemplated that two or more pressure switches be placed in series at the same time that two or more pressure switches are placed in parallel. The invention is thus not limited by the number of pressure switches used, the placement (location) of these switches, or the manner in which these switches are connected (e.g., in series or in parallel).

FIG. 11 shows still another simplified circuit 1100 associated with a portable heated seat according to the preferred embodiments. Circuit 1100 is similar to circuit 600 shown in FIG. 7A, but also includes a temperature controlled switch 1102 for selectively activating and deactivating circuit 1100 based on one or more temperature readings. For example, temperature controlled switch may be associated with a thermostat (not shown) that detects the temperature at one or more points on the surface of the heated seat. When the temperature (or average temperature) is below a predetermined lower limit (e.g., 100° F.), circuit 1100 will be automatically activated by temperature controlled switch 1102. On the other hand, when the temperature (or average temperature) is above a predetermined lower limit (e.g., 110° F.), circuit 1100 may be automatically deactivated by temperature controlled switch 1102. In this manner, the temperature of the heated seat can be automatically controlled based on real-time temperature readings on its surface (or other determined locations).

Another type of sensor switch that may be utilized according to a preferred embodiment of the present invention is a vibration switch. When the heated seat apparatus is in use, the surface of the seat will experience slight vibrations and movement continually while a person is seated on the apparatus. These slight vibrations and movements will trigger a sensor to send signals to an integrated circuit microcontroller. The signal will then reset a timer circuit. If the timer circuit has not been reset within, for example, 8 minutes, the microcontroller will switch off power to the heater, and accordingly, the application of heat to the apparatus. In this manner, the vibration sensor acts in conjunction with the microcontroller to provide power save functionality to automatically turn off the heater and conserve battery power when the apparatus is not in use.

In FIG. 9, the sensor 902 can be replaced with a vibration switch. The vibration sensor acts as a tilt sensor/rolling ball switch, but can be used to detect vibration instead of tilt. A ball is encapsulated in a cylinder. When the cylinder is tilted it acts as a switch, such that the ball either electrically closes or opens the circuit depending on where the ball is. In normal operation for a heated seat in the at least one embodiment, the ball is on the sensor. Any slight vibration causes the ball inside to momentarily jump off the sensor, creating a signal to the microcontroller. A suitable vibration switch is provided by Yusan Electronic Co. Ltd., as the SW-200 Series.

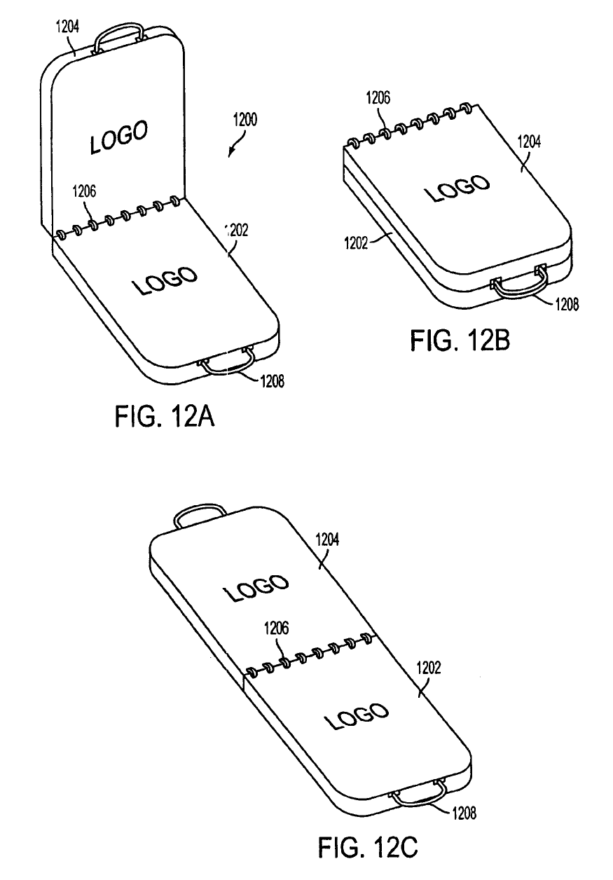

According to various embodiments, a heated backrest is also provided. For example, as shown in FIGS. 12A-C, a portable seating unit 1200 may include a seat portion 1202 and a backrest portion 1204 connected to each other at a connection section 1206. It will be understood that seat portion 1202 may be substantially similar to the heated seats described above, and that backrest portion 1204 may be similar to seat portion 1202 with possible modifications including temperature range (e.g., to account for variations in sensitivity between the users legs and posterior and the user's back) and size (e.g., thickness). It will also be understood that seat and backrest portions 1202 and 1204 may be connected at connection section 1206 using any suitable means. As shown in FIGS. 12A-C, a handle 1208 may also be provided to aid a user in transporting seating unit 1200. Moreover, although not shown, a latch or other mechanism for keeping seat and backrest portions 1202 and 1204 in a closed position (as shown in FIG. 12B) may also be used. It is also noted that, as shown in FIG. 12C, seating unit 1200 may be capable of being fully opened such that seat and backrest portions 1202 and 1204 are coplanar. As also shown in FIGS. 12A-C, one or more logos (e.g., manufacturer's information, advertisements, and the like) may be included at one or more locations of seating unit 1200.

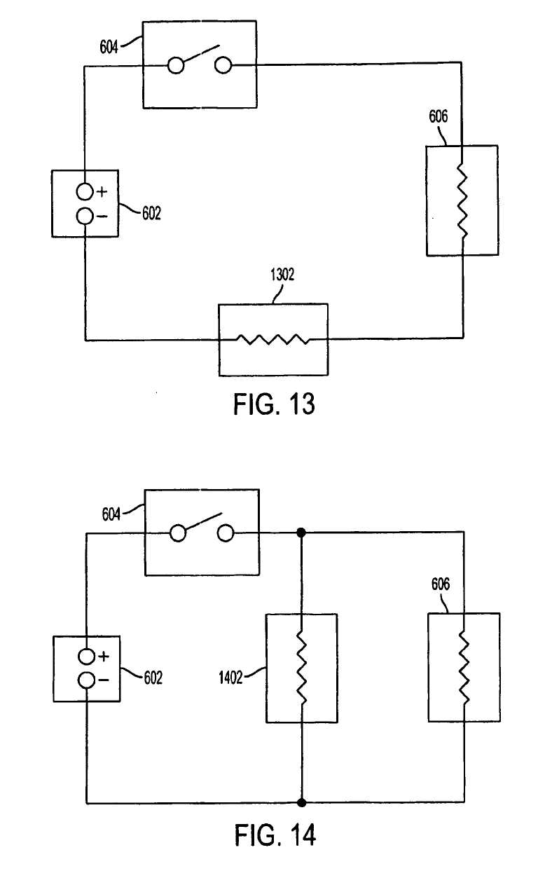

According to various embodiments, although not shown in FIGS. 12A-C, a separate heating element may be used for both seat and backrest portions 1202 and 1204. For example, as shown in FIG. 13, a circuit may be used that is substantially similar to circuit 600 shown in FIG. 6, but also includes a second heating element 1302 connected in series with heating element 606. According to various other embodiments, as shown in FIG. 14, a second heating element 1402 being used for backrest portion 1204 may be connected in parallel with heating element 606.

According to at least one embodiment of the present invention, the heated seat includes an integrated circuit microprocessor that receives signals from a user interface panel and controls the application of power to the heater assembly for generating heat to the surface. In at least one embodiment, the user interface includes a switch or push button that enables a user to select three power levels, or heat settings. These power levels correspond to high, medium, and low power levels, which in turn affect the pulse-width modulator (PWM) to apply comparatively more heat or less heat (referring to FIG. 8, this affects the duty cycle). As can be appreciated, a higher power level may be selected by a user when the heated seat is used in an environment that is very cold, whereas a lower power level may be selected when the environment is not perceived as being quite as cold. Since, in various embodiments, the heated seat is powered by a battery pack, the use of a comparatively lower power level results in less power being used, which conserves battery power. Thus, if a user wishes to use the heated seat with the battery pack for several hours, the user may select a lower power level so that the seat will continue to provide heat for a comparatively longer period of time. Although in various embodiments three power levels are provided, it can be appreciated that more or less power levels can be provided without detracting from features of the invention.

By incorporating capability for selecting between three distinct power levels, the user also is able to adjust how quickly the heated seat reaches a desired temperature range to provide comfort for the user. More specifically, if the user desires to be warmed as soon as possible, the user will selected the highest power setting until the user begins to sense the application of heat to the seating surface. In at least one embodiment, the highest heat seating can be used as an initial heat ramp until the user begins to feel comfortable. At that point, the user will then adjust the heat setting by selecting one of the two other high/low settings. Thus, by adjusting the power levels between higher and lower settings, a user is able to operate the heated seat so as to heat up more quickly than if only one or two power levels were provided.

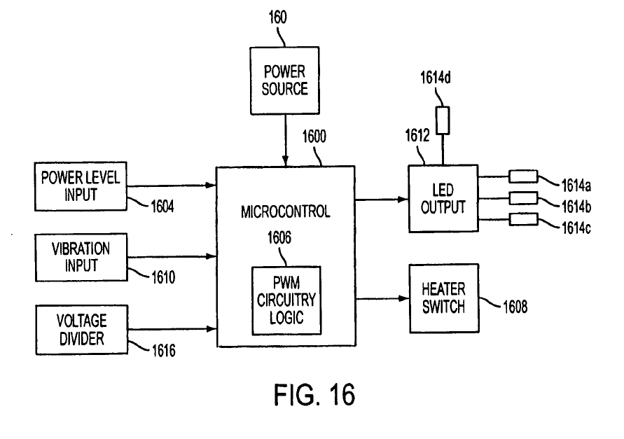

FIG. 16 illustrates an integrated circuit microcontroller assembly in accordance with at least one embodiment of the present invention. As can be seen, microcontroller 1600 receives DC power from power source 1602. The microcontroller 1600 can be, for example, an ELAN 78P0458, programmable general purpose 8 bit microcontroller. The power source 1602 may be a rechargeable battery pack, as described above. Alternatively, or in addition, the microcontroller 1600 may accept power inputs from a car adapter or an AC source. The microcontroller also receives a power level input 1604, which is an electrical signal input from a user interface. As illustrated and described below in further detail, the power level input preferably includes an on/off switch or button, and a button, switch, dial, or other adjuster for indicating a power level (although the these may be combined into a single button, switch, dial or knob). Based upon this input, the PWM circuitry logic 1606 programmed within microcontroller 1600 determines a PWM duty cycle, which is used to turn on and off the heater switch 1608 for applying power or disconnecting power from the heater.

In at least one embodiment, the microcontroller sends one or more signals to a panel printed circuit board assembly to trigger a display on the user interface. The main power switch or button may be a lighted switch/button to provide visual confirmation to the user that the heated seat is operating. Likewise, the power level switch/button may be lighted to provide a visual indication to the user concerning the power level at which the apparatus is operating. Alternatively, the switches/buttons trigger one or more LEDs that are separate from the switches/buttons themselves, to provide a visual indication of the selected power level. For an indication of power levels, multiple LEDs may be provided. In the at least one embodiment having three power levels, three LEDs will be illuminated when the highest power setting is selected, two LEDs will be illuminated when the medium power setting is selected, and a single LED is illuminated for the lowest power setting. The microcontroller receives a user's power level selection from the power level button as a signal from a circuit board associated with the user interface. Again, based on the user's power setting, a PWM circuit determines the appropriate duty cycle, and the microcontroller sends power to the heater in accordance with the selected duty cycle. The PWM circuitry can be in a separate microcontroller, such as that shown and described with reference to FIG. 7B, or in a general microcontroller that can also provide control of other features, such as lighting, powersave, and low battery cutoff, as will now be described.

Referring back to FIG. 16, microcontroller 1600 provides one or more electrical signals to LED output(s) 1612 to provide an indication to the user whether the heated seat is in operation. In one embodiment, when the microcontroller 1600 receives input from power level input 1604 indicating that the heated seat is powered on, at least a first LED 1614d is illuminated. Depending upon the power level that is selected at power level input 1604, one or more of the LEDs 1614a, 1614b, and 1614c are illuminated from LED output 1612. In a preferred embodiment, capability is provided for three power levels, and each of three LEDs receives a signal from a separate pin on microcontroller 1600.

Microcontroller 1600 additionally receives an electrical signal from a vibration input 1610. As described above, in at least one embodiment, a vibration sensor sends an electrical signal whenever the heated seat is powered on and a vibration is experienced, which temporarily moves a ball from atop the sensor. The microcontroller 1600 uses this electrical signal to reset a counter, which times out if no vibration is experienced within a predetermined amount of time. If the timeout circuit within microcontroller 1600 expires, it is determined that the heated seat is not in use, and it enters a powersave state, whereby the heater switch is turned off such that no power is supplied to the heater, and the LEDs 1614a-d are turned off to signal to the user that the heated seat is not providing heat.

Microcontroller 1600 also receives input from voltage divider 1616. This is used to detect when the battery source has reached a critically low battery level. The voltage divider provides an analog voltage signal that is based upon the battery voltage level Vref. This level is then supplied to an analog to digital converter input pin in the microcontroller 1600, which then converts the signal into a digital value. If the digital value falls below a threshold value stored in microcontroller memory, the firmware executes a routine to turn off the heater supply 1608 and to send a blinking signal to LED output 1612 to indicate to the user that the battery must be re-charged. In at least one embodiment, when the firmware enters this state, all three LEDs begin blinking. This circuitry prevents overdischarging, which may prematurely cause the battery to become permanently discharged.

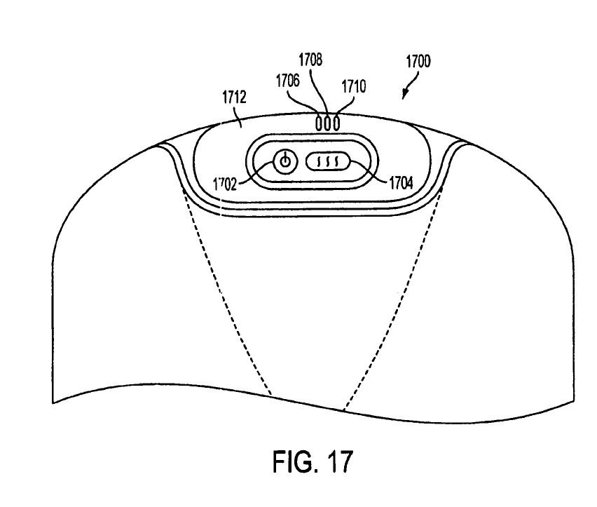

In at least one embodiment, as shown in FIG. 17, the user interface 1700 includes a main power switch 1702 in addition to a power level switch 1704. The main power switch sends a signal to the microcontroller (as described with reference to FIG. 16) to turn on or off the apparatus. As described above, the power level switch allows the user to adjust the duty cycle by which heat is applied, so as to affect the comparative temperature, or heat level provided by the apparatus. The user interface also includes a surface 1712 by which a user can discern illumination of any of LEDs 1706, 1708, and 1710.

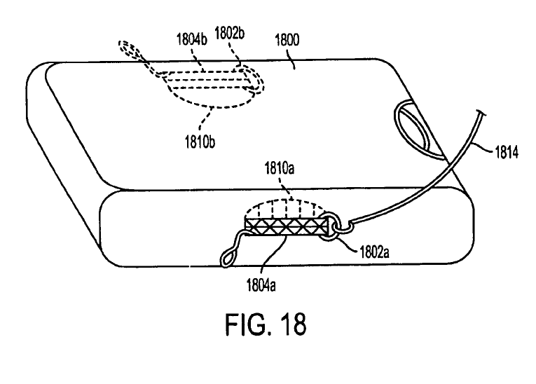

In addition to providing heating to a seating surface, in at least one embodiment, the heated seat also provides heating for hands. The heated seat can provide integrated pockets that can hold items such as keys, tickets, an identification, etc. Since these pockets are within the heated seat itself, as shown in FIG. 18, the interior of the heated seat 1800 will be warmed as the heated seat apparatus is operating. Accordingly, these pockets, preferably located on both sides of the unit, also can be used as hand warmers. As shown in FIG. 18, the pockets 1810a, 1810b on both sides include a zipper 1804a, 1804b to open and close. In addition, the heated seat can include two rings 1802a and 1802b by which a user can securely fasten a strap 1814 (partially depicted) to easily transport the heated seat by carrying the apparatus, for example, on the user's shoulder.

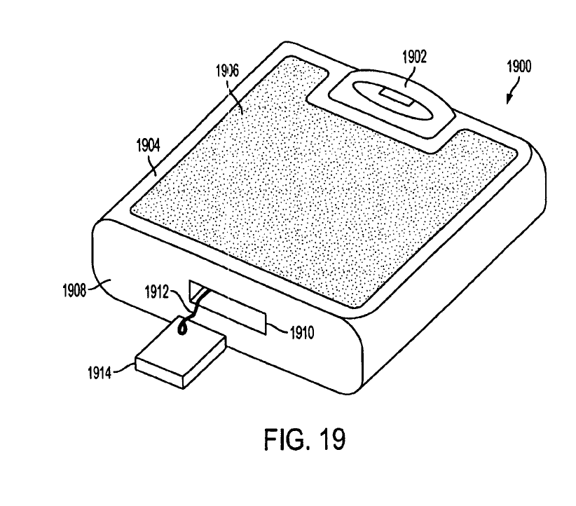

In various embodiments, the heated seat is comprised of a foam material that provides both cushioning and support. The heater assembly as described above is then positioned directly atop the cushion material via an adhesive, so as to be as close to the seating surface as possible. As shown in FIG. 19, heated seat 1900 includes an integrated handle 1902 and a seating area 1904, which is nearly covered by heater 1906. Foam cushion material 1908 comprises substantially the entire seating surface for the heated seat. When in use, the handle can be viewed between a user's thigh area, and the user interface can therefore be viewed even while a user is seated on the apparatus. In this manner, the user can turn on and off the apparatus, adjust the power level, and view the LED indicators while remaining seated on the heated pad of the seat.

Continuing with FIG. 19, the foam 1908 includes a cut-out section 1910 to receive a rechargeable battery 1914. In at least one embodiment, the cut-out section is shaped to receive the battery 1914 with a snug fit, minimizing any rattle or shaking. A connector wire 1912 from battery 1914 connects with a connector wire within the cut-out section 1910 to connect the battery to the microcontroller described above.

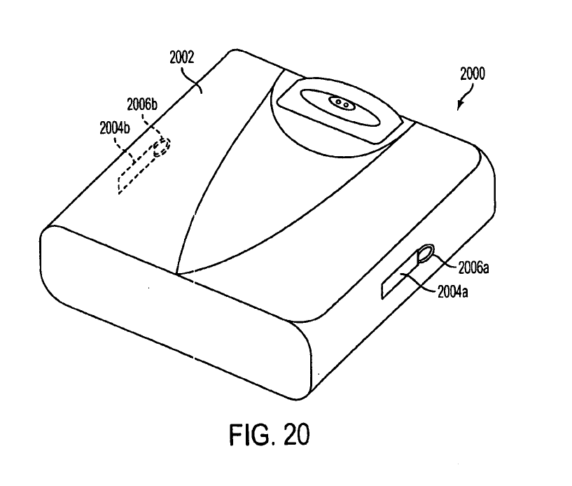

Lastly, as shown in FIG. 20, a durable fabric, such as nylon, is then placed upon the seat 2000 as a cover 2002. Preferably, within the nylon fabric, integrated pockets 2004a and 2004b are provided, in addition to rings 2006a and 2006b for attaching a carrying strap.

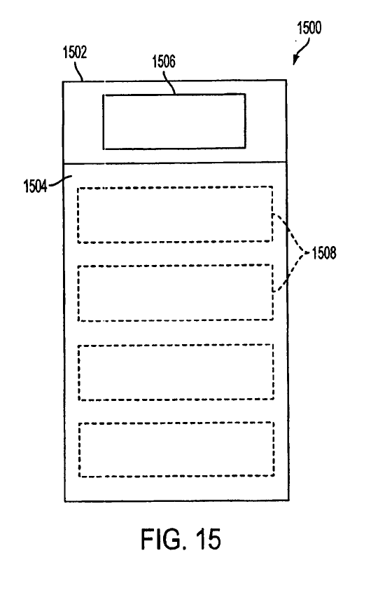

It will be understood that, although the invention is described with particular attention to portable heated seats for use with, for example, stadium seating, the invention is not limited in this manner. For example, heated seats (with or without heated backrests) may be used with golf cart seats, car seats, chairs, and the like. Moreover, the concepts described can be extended, for example, to couches or bedding, whether portable or otherwise. For example, the principles described herein may be used in connection with a sleeping bag unit 1500 as shown in FIG. 15. Sleeping bag unit 1500 includes a sleeping bag head portion 1502 and a sleeping bag body portion 1504. As shown, head portion may include a pillow 1506. Moreover, body portion 1504 may include one or more heating elements 1508 similar to the heating units described above. Although four separate heating elements 1508 are shown in FIG. 15, it will be understood that this is not required. Rather, one, two, three, or more than four such heating units may be used. Moreover, it will be understood that the various features associated with heating units described above may be implemented in connection with heating elements 1508 shown in FIG. 15, which may be connected in parallel, in series, or a combination thereof. Moreover, although not shown, sleeping bag unit 1500 may also include another heating unit in head portion 1502. Regardless of their respective locations, when more than one heating unit is being used, according to various embodiments, the temperature setting for each (or at least some) of these heating units may be separately controlled in a manner such as described above. In this manner, for example, a user may be able to set a desired temperature level in the upper regions of bag unit 1500, and a lower temperature level in the lower region of bag unit 1500 (e.g., in the area where the user's feet will be located when bag unit 1500 is in use). As another example, when two people are using sleeping bag unit 1500, and when there are multiple heating units next to each other (rather than simply above and below each other as shown in FIG. 15), different temperature settings may be associated with the different simultaneous users of bag unit 1500.

It will also be understood that the heated seat and/or heated backrest as described herein may be used in a variety of situations. For example, as explained above, a heated seat and/or heated backrest may be used to combat cold temperatures and otherwise uncomfortable seating at a sporting event, concert, and the like. In addition to these situations, it is noted that a heated seat and/or heated backrest may be used in a vehicle, home, or other location for therapeutic purposes (e.g., to relieve sore back discomfort, etc.).

Other embodiments, extensions, and modifications of the ideas presented above are comprehended and should be within the reach of one versed in the art upon reviewing the present disclosure. Accordingly, the scope of the present invention in its various aspects should not be limited by the examples presented above. The individual aspects of the present invention, and the entirety of the invention should be regarded so as to allow for such design modifications and future developments within the scope of the present disclosure.

What is claimed is:

1. A portable heated seating apparatus, comprising:
cushion material for providing seating support;
a heating element positioned at or substantially near a surface of the cushion material for generating heat from electrical current;
a power source located within the cushion material for supplying current to the heating element, wherein the cushion material includes an opening for removable insertion of the power source; and
a user-operated power selector located on the exterior of the seating apparatus and operatively connected between the power source and the heating element for a user to selectively activate or deactivate the seating apparatus.

2. The portable heated seating apparatus of claim 1, further comprising a display for indicating whether the seating apparatus is activated, wherein the display is discernable by a user while remaining seated upon the cushion material.

3. The portable heated seating apparatus of claim 2, wherein the display includes at least one LED.

4. The portable heated seating apparatus of claim 1, wherein the user-operated power selector is further adapted for a user to select among a plurality of power levels to adjust a temperature level generated by the heating element.

5. The portable heated seating apparatus of claim 4, wherein the user-operated power selector includes a plurality of buttons or switches for selecting a power level.

6. The portable heated seating apparatus of claim 4, further comprising a display for indicating the selected power level when the seating apparatus is activated, wherein the display is visible to a user while remaining seated upon the cushion material.

7. The portable heated seating apparatus of claim 1, further comprising a temperature controller operatively connected to the power source, power selector, and heating element, wherein the temperature controller receives electrical input from the power source and the power selector and controls the heating element by pulse width modulation.

8. The portable heated seating apparatus of claim 7, wherein the temperature controller is an integrated circuit.

9. The portable heated seating apparatus of claim 7, wherein the temperature controller additionally controls a display for indicating whether the seating apparatus is activated.

10. The portable heated seating apparatus of claim 7, wherein the user-operated power selector is further adapted for a user to select between a plurality of power levels, and wherein the temperature controller adjusts a pulse width duty cycle in correspondence with the selected power level to control a temperature level generated by the heating element.

11. The portable heated seating apparatus of claim 1, further comprising a temperature controller that receives input from the power source, the power selector, and a vibration sensor, and wherein the temperature controller disconnects current from the heating element when either the power source is switched off or when no user movement is detected via the vibration sensor for a predetermined amount of time.

12. The portable heated seating apparatus of claim 1, further comprising a temperature controller that receives input from the power source and the power selector, and wherein the temperature controller disconnects current from the heating element upon determining that voltage from the power source is below a critical threshold.

13. A portable heated seating apparatus, comprising:
a heating element for generating heat from electrical current;
a temperature controller operatively connected to the heating element to control activation of the heating element based on pulse width modulation; and
a user-operated power selector adapted for selection of a power level,
wherein the temperature controller adjusts a pulse width duty cycle in correspondence with the selected power level to control a temperature level generated by the heating element.

14. The portable heated seating apparatus of claim 13, wherein the power selector is located on the seating apparatus such that a user can adjust the power level while remaining seated upon the apparatus.

15. The portable heated seating apparatus of claim 13, further comprising a display for indicating the selected power level, wherein the display is visible to a user while remaining seated upon the apparatus.

16. The portable heated seating apparatus of claim 13, further comprising a vibration sensor in communication with the temperature controller,
wherein the temperature controller disconnects current from the heating element when no user movement is detected via the vibration sensor for a predetermined amount of time.

17. The portable heated seating apparatus of claim 13, wherein the temperature controller disconnects current from the heating element upon determining that voltage supplied from a power source is below a critical threshold.

18. A portable heating device, comprising:
a heating element for generating heat from electrical current;
a temperature controller operatively connected to the heating element to control activation of the heating element based on pulse width modulation;
a removable and rechargeable power source for supplying current to the heating element and the temperature controller; and
a sensor in communication with the temperature controller,
wherein the temperature controller disconnects current from the heating element upon determination via the sensor that the device is not in use by a user.

19. The portable heating device of claim 18, further comprising a display indicating when the device is in operation, wherein the display turns off to indicate that the device is in a powersave mode when no user movement is detected for a predetermined amount of time.

20. The portable heating device of claim 18, wherein the temperature controller disconnects current from the heating element upon determining that voltage supplied from the power source is below a critical threshold.

21. The portable heating device of claim 19, further comprising a display for indicating when the voltage supplied from the power source is below a critical threshold.
